(19) United States
(12) Patent Application Publication
(10) Pub. No.: US 2012/0187833 A1
(43) Pub. Date: Jul. 26, 2012

(54) DEVICE FOR GENERATING HYPERFREQUENCY WAVES HAVING A CATHODE WHEREOF EACH END IS CONNECTED TO A VOLTAGE SOURCE

(75) Inventors: Jean-Pierre BRASILE, Colombes (FR); Dominique FASSE, Colombes (FR); Patrick SIROT, Colombes (FR); Dominique JOUSSE, Colombes (FR)

(73) Assignee: THALES, Neuilly Sur Seine (FR)

(21) Appl. No.: 13/338,121

(22) Filed: Dec. 27, 2011

(30) Foreign Application Priority Data
Dec. 29, 2010 (FR) 1005162

(51) Int. Cl. H01J 25/50

(52) U.S. Cl. 315/39.55

(57) ABSTRACT

The device according to the invention for generating hyperfrequency waves, of the magnetron type, comprises: a cathode, elongated between first and second longitudinal ends; an anode, surrounding the cathode and comprising an inner surface oriented toward the cathode and delimiting a plurality of resonant cavities distributed along the periphery thereof; and a voltage source, to establish a potential difference between the cathode and the anode. The cathode is electrically connected to the voltage source by each of its longitudinal ends, to bring those two ends to substantially equal electric potentials. The generating device also comprises a device for adjusting the longitudinal length of each resonant cavity, the adjusting device comprising at least one mobile element defining a longitudinal end of at least one resonant cavity.

### BACKGROUND

The present invention relates to a device for generating hyperfrequency waves, of the magnetron type, comprising:

a cathode, elongated in a longitudinal direction, between first and second longitudinal ends,

an anode, surrounding the cathode and comprising an inner surface oriented toward the cathode and delimiting a plurality of resonant cavities distributed along the periphery thereof, the anode also comprising an outer surface, opposite the inner surface, and

a voltage source, to establish a potential difference between the cathode and the anode.

Such hyperfrequency wave generating devices are known and are in particular used in radar systems. The magnetron is one such device for which the cathode is at a lower potential than that of the anode. The cathode behaves like an electron source radially emitting electrons toward the anode, in the central interaction space situated between the cathode and the anode. Under the effect of a longitudinal magnetic field and the interaction with the cavities of the magnetron, the emitted electrons begin to rotate transversely between the cathode and the anode and group together, which makes it possible to generate the hyperfrequency wave owing to the interaction of the electrons with the cavities of the magnetron.

However, the known devices are not fully satisfactory. In fact, at a strong current, the electrons are blown outside the interaction space following a helix before even having been able to give their energy to the hyperfrequency wave. This results in a significant output loss of the magnetron.

One considered solution is to increase the intensity of a longitudinal magnetic field. This, however, requires increasing the weight and bulk of a concentrator generating this longitudinal magnetic field, which is not desirable. Another solution is to increase the longitudinal length of the anode. However, this results in increasing the bulk of the magnetron, which is, again, not desirable.

It is known from the document “Double-Sided Relativistic Magnetron” (Agafonov et al. in “Pulsed Power Conference, 1997. Digest of Technical Papers. 1997 11th IEEE International,” pp 774-779) to power the cathode of a magnetron by the two longitudinal ends thereof, so as to limit the longitudinal drift of the electrons in the interaction space. However, the device described in that document does not make it possible to vary the frequency of the waves generated by the magnetron.

One aim of the invention is to propose a device for generating hyperfrequency waves with a reduced bulk and making it possible to vary the wavelength of the waves generated over a wide wavelength spectrum. Another aim is to optimize the output of the generating device.

To that end, the invention relates to a hyperfrequency wave generating device of the aforementioned type, wherein the cathode is electrically connected to the voltage source by each of its longitudinal ends, to bring those two ends to substantially equal electric potentials, and the generating device comprises a device for adjusting the longitudinal length of each resonant cavity, the longitudinal length being defined between the longitudinal ends of the resonant cavity, the adjusting device comprising at least one mobile element defining a longitudinal end of at least one resonant cavity.

According to specific embodiments, the generating device according to the invention also comprises one or more of the following features, considered alone or according to all technically possible combinations:

the adjusting device comprises at least one first mobile element delimiting a first longitudinal end of at least one resonant cavity, at least one second mobile element delimiting a second longitudinal end of the or each resonant cavity, and means for moving each mobile element longitudinally,

the plurality of resonant cavities comprises at least one resonant output cavity comprising an output portion emerging in the outer surface of the anode, the output portion being symmetrical relative to a median radial plane perpendicular to the longitudinal direction, and the movement means are adapted to move each mobile element so that the or each resonant output cavity remains symmetrical relative to the median radial plane of the output portion,

the adjusting device comprises a single first mobile element and a single second mobile element, each mobile element being shared by all of the resonant cavities, and the movement means of each mobile element comprise a plurality of screw-nut systems, to convert a rotational movement of the screw into a translational movement of the screw, and a system for rotating each screw using a belt,

the anode is symmetrical relative to a median radial plane, perpendicular to the longitudinal direction, and the cathode comprises an electron source, adapted to free the electrons from the cathode toward the anode, the electron source being situated substantially in the median radial plane of the anode,

the voltage source comprises two voltage generators, each voltage generator being electrically connected to a single longitudinal end of the cathode, and the generating device comprises a control module, adapted to control a simultaneous start-up of both voltage generators,

the plurality of resonant cavities comprises a plurality of resonant output cavities each comprising an output portion emerging in the outer surface of the anode, and a plurality of intermediate cavities inserted between the output cavities, the number of intermediate cavities inserted between two consecutive output cavities being equal to each pair of consecutive output cavities,

the voltage source comprises two voltage generators, each voltage generator being electrically connected to a single longitudinal end of the cathode, each voltage generator comprising at least one capacitor to supply the cathode with energy,

the voltage source comprises two branches for powering one end of the cathode, each branch extending from the anode to an end of the cathode, each branch being electrically identical to the other branch,

the longitudinal ends of the cathode are electrically isolated from one another.

### BRIEF DESCRIPTION OF THE DRAWINGS

Other features and advantages will appear upon reading the following description, provided solely as an example and done in reference to the appended drawings, in which:

FIG. 1 is a partial cross-sectional view in a longitudinal plane of the generating device according to the invention,

FIG. 2 is a cross-sectional view of the device, in a radial plane marked II-II in FIG. 1,

FIG. 3 is a cross-sectional view of the device, in a radial plane marked in FIG. 1,

FIG. 4 is a perspective view of an element of a device for adjusting the length of the resonant cavities of the device of FIG. 1,

FIG. 5 is an electrical diagram of the generating device of FIG. 1,

FIG. 6 is a diagrammatic elevation view of a cathode of a generating device, according to one alternative of the invention, and

FIG. 7 is a perspective view of a portion of the cathode of FIG. 6.

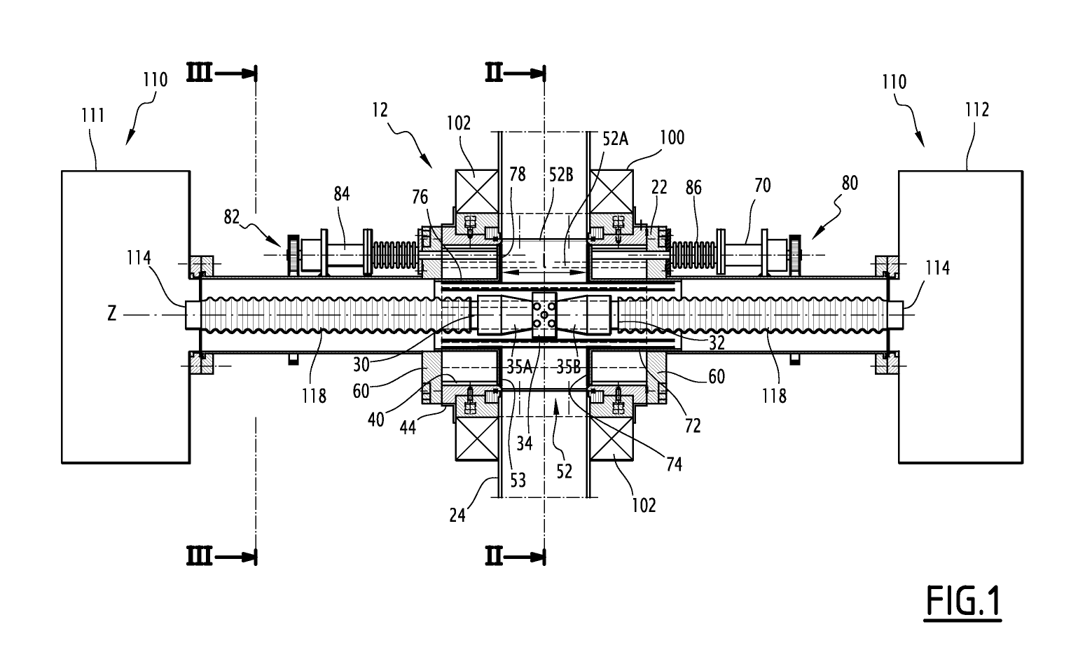

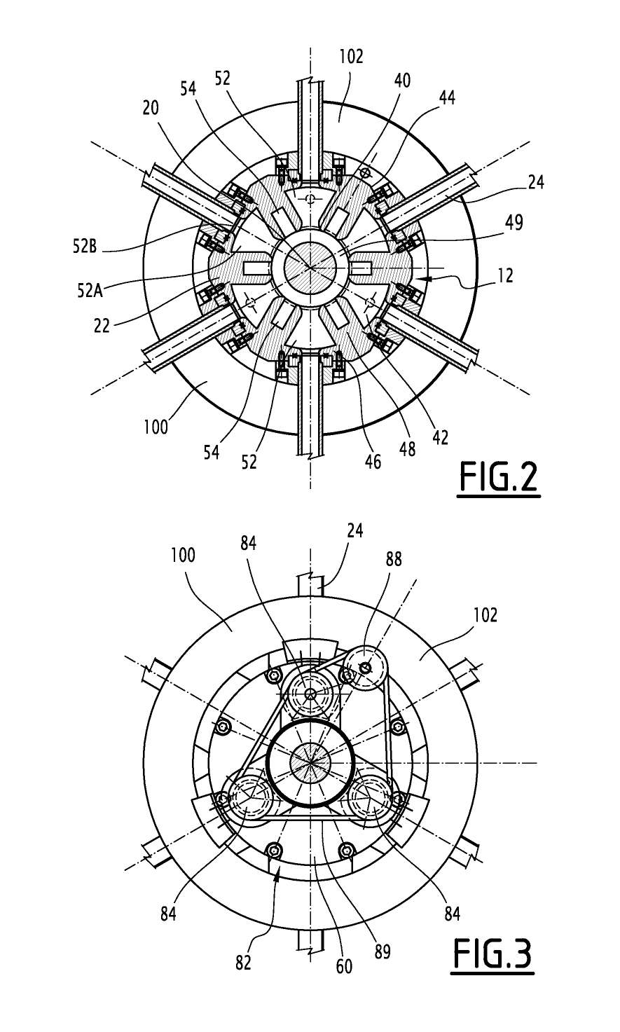

As visible in FIGS. 1 and 2, the device 10 according to the invention comprises a magnetron 12 and a plurality of waveguides 24. The magnetron 12 comprises a cathode 20 and an anode 22 surrounding the cathode 20.

Hereafter, the orientation terms “longitudinal,” “radial” and “transverse” will be used, and should be understood as follows:

the cathode 20 is elongated in the longitudinal direction,

the radial direction is oriented from the cathode 20 toward the anode 22, perpendicular to the longitudinal direction, and

the transverse direction is orthogonal to the longitudinal and radial directions and defines, with the radial direction, a radial plane perpendicular to the longitudinal direction.

The cathode 20 extends along a longitudinal axis Z, from a first longitudinal end 30 to a second longitudinal end 32. It is preferably of revolution around the longitudinal axis Z.

The cathode 20 comprises an electron source 34 gripped between two tapered fingers 35A, 35B. The electron source 34 is typically equidistant from the longitudinal ends 30, 32 of the cathode 20, formed at the opposite ends of the fingers 35A, 35B.

The electron source 34 is adapted to emit electrons. Typically, the electron source 34 is adapted to emit electrons under the effect of a strong electric field. The electron source 34 is for example cylinder made from tungsten or, as shown, pyrolytic carbon.

The cathode 20 is at a lower electric potential than the electric potential of the anode 22, so that an electric field exists between the cathode 20 and the anode 22, oriented from the cathode 20 toward the anode 22.

The anode 22 surrounds the cathode 20. The anode 22 extends substantially longitudinally, coaxially with the cathode 20. It has an inner surface 40, oriented toward the cathode 20, delimiting a plurality of resonant cavities 42 distributed over the periphery of the anode 22, and an outer surface 44, opposite the inner surface 40. The anode 22 is formed from a conductor material, typically steel, graphite or copper.

In the illustrated example, the anode 22 is symmetrical relative to a median radial plane, perpendicular to the longitudinal axis Z. In one preferred embodiment of the invention, the electron source 34 is, as shown, situated in the median radial plane of the anode 22.

As shown in FIG. 2, the anode 22 comprises a cylindrical body 46 and a plurality of fins 48 extending radially toward the cathode 20. The cylindrical body 46 delimits the outer surface 44 and a portion of the inner surface 40. The fins 48 protrude from the cylindrical body 46 toward the inside of the anode 22 and delimit a portion of the inner surface 40.

It will be noted that the term “cylindrical” is to be understood broadly here and covers both cylinders of revolution and cylinders with square, hexagonal, or other sections.

Each cavity 42 emerges in a substantially cylindrical central space 49 extending at the center of the anode 22. The central space 49 extends substantially longitudinally. The cathode 20 is positioned substantially at the center of the central space 49.

In the illustrated example, the plurality of resonant cavities 42 comprises a plurality of large resonant cavities 52 and small resonant cavities 54, arranged alternating with one another around the cathode 20. The radial section of each small resonant cavity 54 is smaller than the radial section of each large resonant cavity 52. Preferably, the small 54 and large 52 resonant cavities all have the same longitudinal length l.

Each large cavity 52 is delimited by two fins 48 and by the cylindrical body 46. Each small cavity 54 is delimited inside a fin 48 by a radial orifice opening opposite the cathode 20. The anode 22 thus has a “rising sun” type configuration. This configuration makes it possible to limit the risk of oscillations on disturbance frequencies, and thereby to increase the output of the device 10.

According to one preferred embodiment of the invention, each large cavity 52 constitutes a resonant output cavity, and each small resonant cavity 54 constitutes an intermediate resonant cavity. The cavities 42 are arranged so that the number of intermediate cavities 54 arranged between two consecutive output cavities 52 is equal for each pair of output cavities 52.

Each output cavity 52 comprises a primary portion 52A, delimited by the cylindrical body 46 and by two fins 48, and an output portion 52B. The output portion 52B extends from the primary portion 52A toward the outside of the anode 22, through the cylindrical body 46, and emerges in the outer surface 44, opposite a waveguide 24. The output portion 52B is made up of a radial orifice formed in the cylindrical body 46 along a radial axis of symmetry of the cavity 52.

The inner surface 40 of the anode 22 defines an annular connecting surface 53 between the primary portion 52A and the output portion 52B. Preferably, this annular surface 53 is curved at all points, i.e. it does not have any edges or protrusions, so as to limit breakdown risks.

In the example illustrated in FIGS. 1 and 2, the output portion 52B has a constant transverse section. Alternatively, the output portion 52B has a transverse section increasing from the inner surface 40 toward the outer surface 44.

The output portion 52B is symmetrical relative to a median radial plane of the portion. Preferably, the median radial plane of the output portion 52B of each output cavity 52 is combined with the median radial plane of the output portion 52B of each other resonant output cavity 52. In one preferred alternative of the invention, the median radial plane of the output portions 52B is combined with the median radial plane of the anode 22.

No intermediate cavities 54 emerge in the outer surface 44.

Preferably, the output cavities 52 are identical to one another and the intermediate cavities 54 are identical to one another.

Alternatively, the generating device 10 does not comprise any intermediate cavities 54, all of the cavities 42 of the device 10 being output cavities 52.

Returning to FIG. 1, the anode 22 also comprises two longitudinal closing rings 60 of the cavities 42. Each ring 60 thus delimits a longitudinal end of the anode 22.

Each waveguide 24 extends from the outer surface 44 of the anode 22 toward the outside of the generating device 10.

As visible in FIG. 1, the generating device 10 also comprises a device 70 for adjusting the longitudinal length l of each resonant cavity 42. The longitudinal length l of each resonant cavity 42 is defined between two longitudinal ends 74, 78 of the cavity 42.

The adjustment device 70 comprises a first mobile element 72 defining a first longitudinal end 74 of each resonant cavity 42, a second mobile element 76 defining a second longitudinal end 78 of each cavity 42, and longitudinal movement means 80, 82 of each mobile element 72, 76.

Alternatively, the adjustment device 70 comprises a single mobile element 72, 76, a longitudinal end 74, 78 of each cavity 42 then being defined by a ring 60.

The movement means 80, 82 are adapted to move each mobile element 72, 76 so that each resonant output cavity 52 remain symmetrical relative to the median radial plane of its output portion 52B. Preferably, the movement means 80, 82 are adapted to move each mobile element 72, 76 so that each resonant cavity 42 remains symmetrical relative to the median radial plane of the output portions 52B.

Alternatively, the movement means 80, 82 can be maneuvered independently of one another, for an independent movement of the mobile elements 72, 76.

The longitudinal movement means 80, 82 of each mobile element 72, 76 are typically formed by a plurality of screw-nut systems 84, each screw-nut system 84 comprising a screw 86 rotated and collaborating with a tapping of one of the rings 60 to convert the rotational movement of the screw 86 into a translational movement thereof along the axis Z. At one end, the screw 86 is secured in translation with the mobile element 72, 76, so that the longitudinal translation of the screw 86 drives the translation of the mobile element 72, 76.

As visible in FIG. 3, the longitudinal movement means 80, 82 preferably comprise three screw-nut systems 84 distributed over the periphery of the anode 22, around the longitudinal axis Z, so that the force is distributed homogenously over the mobile element 72, 76.

In the illustrated example, the longitudinal movement means 80, 82 also comprise a system 88 for jointly rotating the three screws 86, using a belt 89. Thus, the screw-nut systems 84 are all driven simultaneously, which makes it possible to vary the longitudinal length of each cavity 42 simultaneously.

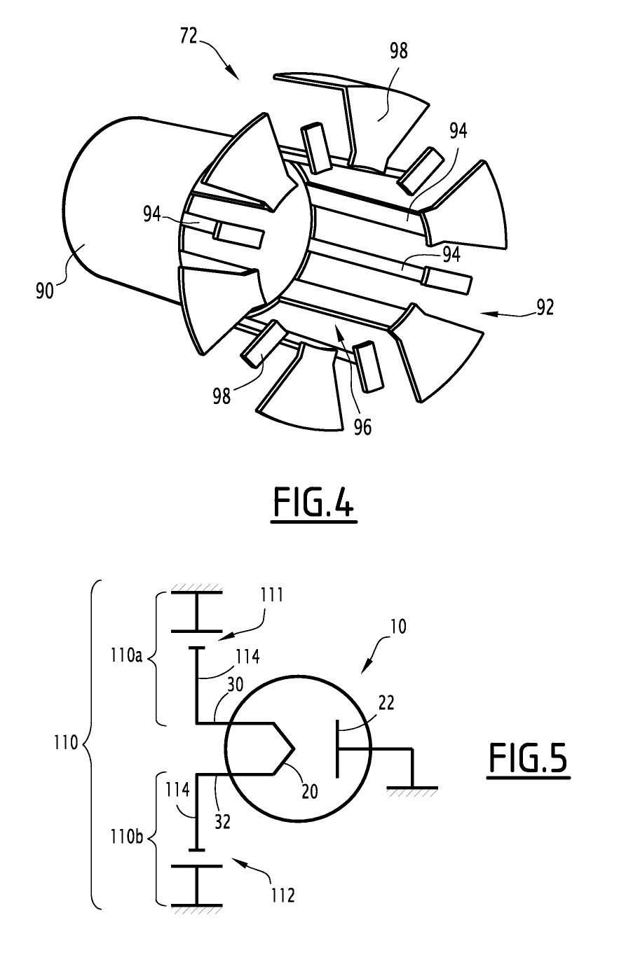

FIG. 4 shows the mobile element 72. It will be noted that the mobile element 76 is identical to the mobile element 72 and that the description provided below is also valid for the mobile element 76.

The mobile element 72 comprises a cylindrical base 90, extending longitudinally, and an end collar 92, extending radially outwardly from the base 90. The base 90 and the collar 92 are secured to one another and are preferably made in a single piece.

The base 90 comprises a plurality of longitudinal arms 94 separated by longitudinal slots 96. The arms 94 are adapted to engage in the cavities 42. The slots 96 are adapted to receive the fins 48.

The collar 92 is made up of a plurality of panels 98. Each panel 98 is connected to an arm 94. Each panel 98 has a shape complementary to the radial section of a cavity 42. For each output cavity 52, the associated panel 98 has a shape complementary to the sole primary portion 52A of the cavity 52.

As shown in FIGS. 1 to 3, the generating device 10 also comprises a concentrator 100 extending around the anode 22.

The concentrator 100 is adapted to generate a longitudinal magnetic field in the central space 49 and in the cavities 42, to cause the electrons emitted by the electron source 34 to rotate. In a known manner, the concentrator 100 comprises, as shown, two Helmholtz coils 102 positioned parallel to one another, each coil 102 extending in a radial plane and having longitudinal axis Z as axis.

As visible in FIG. 5, the generating device 10 also comprises a voltage source 110 between the cathode 20 and the anode 22. The voltage source 110 is adapted to establish a negative potential difference between the cathode 20 and the anode 22.

Specifically, the cathode 20 is electrically connected to the voltage source 110 by each of its longitudinal ends 30, 32 so that the electric potential of each end 30, 32 is substantially equal to the electric potential of the other end 30, 32. The voltage source 110 is thus adapted to supply the cathode 20 with current through each of these longitudinal ends 30, 32. Thus, during operation of the generating device 10, the current circulating between the first end 30 and the electron source 34 generates a first transverse magnetic field of the central space 39, between the first end 30 and the electron source 34, while the current circulating between the second end 32 and the electron source 34 generates, in the central space 39, between the second end 32 and the electron source 34, a second transverse magnetic field, in a direction opposite the first transverse magnetic field.

The voltage source 110 is preferably a direct voltage source, so that, during operation, the electric potential of each end 30, 32 of the cathode 20 remains substantially constant. The voltage source 110 is adapted to establish a potential difference V between the cathode 20 and the anode 22 such that:

$$V = \sqrt{\frac{P \times R}{η}}$$

where P is the power of the hyperfrequency wave generated by the device 10, R is the electric impedance of the magnetron 12, and η Is the output of the magnetron 12. Typically, the electric impedance of the magnetron is comprised between 45 and 55 ohms, and the output is comprised between 35 and 45%.

The voltage source comprises two branches, 110a, 110b, respectively, for powering one end 30, 32, respectively, of the cathode 20. Each branch 110a, 110b extends from the anode 22 to an end 30, 32 of the cathode 20. Preferably, each branch 110a, 110b is electrically identical to the other branch 110a, 110b, i.e. the electrical characteristics (impedance, inductance) of each branch 110a, 110b are similar to the electrical characteristics of the other branch 110a, 110b. Thus, during operation, the current circulating in each branch 110a, 110b is substantially equal to the current circulating in the other branch 110a, 110b, which makes it possible for the transverse magnetic fields to have values substantially equal to one another.

In the example illustrated in FIGS. 1 and 5, the voltage source 110 comprises two voltage generators 111, 112, each voltage generator 111, 112 comprising an electrical connection terminal 114 of a longitudinal end 30, 32 of the cathode 20. Each voltage generator 111, 112 is adapted so that the terminal 114 is at the same electrical potential as the terminal 114 of the other voltage generator 111, 112.

Each longitudinal end 30, 32 of the cathode 20 is electrically connected to the terminal 114 of the voltage generator 111, 112 via an elongate conducting pin (not shown) substantially longitudinally, coaxially with the cathode 20. Each conducting pin is insulated from the anode 22 by an insulating layer 118. Each insulating layer 118 is typically formed from high density polyethylene, or a ceramic.

Each voltage generator 111, 112 is adapted to establish a negative potential difference between the potential of the anode 22 and the potential of the terminal 114.

Preferably, each voltage generator 111, 112 comprises at least one capacitor whereof the discharge powers the cathode 20. This embodiment makes it possible to guarantee the equality of the potential of the terminal 114 of a voltage generator 111 with the potential of the terminal 114 of the other voltage generator 112. Each voltage generator 111, 112 is typically a Marx generator.

In one preferred alternative of the invention, the generating device 10 comprises a control module (not shown), adapted to control a simultaneous start-up of the voltage generators 111, 112. Thus, no potential difference is created upon start-up between the two ends 30, 32 of the cathode 20.

Alternatively, the voltage source 110 comprises a single voltage generator establishing a voltage differential between two terminals, the two longitudinal ends 30, 32 of the cathode 20 being electrically connected to a same first terminal of said two terminals, the anode 22 being connected to the other terminal of said two terminals.

An example of the operation of the device 10 will now be described in reference to FIGS. 1 and 2.

The voltage source 110 establishes a negative potential difference between the anode 22 and the cathode 20. This potential difference generates a radial electric field oriented from the cathode 20 toward the anode 22 and under the effect of which the electron source 34 emits electrons.

These electrons, released from the central space 49, are then subjected to the radial electric field and the longitudinal magnetic field. Under the effect of the combination of these two fields, the electrons rotate around themselves and move transversely in the central space 49, between the cathode 20 and the anode 22. This movement of the electrons generates a radiofrequency electromagnetic wave in the central space 49 and the cavities 42. This wave is amplified owing to the resonant cavities 42 and is captured to be used, for example to power a radar antenna, owing to the waveguides 24.

The electron source 34 of the cathode 20 being supplied with current by each of the two ends 30, 32 of the cathode 20, the current that circulates between the first end 30 and the electron source 34 generates a first transverse magnetic field, while the current that circulates between the second end 32 and the electron source 34 generates a second transverse magnetic field, in the direction opposite the first transverse magnetic field.

Consequently, the electrons circulating in the space 39 are pushed back in a first direction by the first transverse magnetic field, and in a second direction, opposite the first direction, by the second transverse magnetic field. The electrons thus remain confined near the median radial plane of the anode 22.

Owing to the invention, it is possible to reduce the longitudinal length of the anode 22 and reduce the intensity of the longitudinal magnetic field. This results in reducing the weight and bulk of the generating device 10.

Furthermore, the adjusting device 70 makes it possible to vary the wavelength of the radiofrequency wave generated by the generating device 10.

Since the adjustment device 70 comprises a single first element 72 to simultaneously move the first longitudinal end 74 of each resonant cavity 42, and a single second element 76 to simultaneously move the second longitudinal end 78 of each cavity 42, each cavity 42 always has the same longitudinal length as each other cavity 42, which avoids the amplification of disturbance wavelengths that would reduce the output of the generating device 10.

Furthermore, the movement means 80, 82 being adapted so that each resonant output cavity 52 remains symmetrical relative to the median radial plane of the portion of the output thereof 52B, the output of the device 10 is improved.

Lastly, owing to the combination of the symmetrical electric power supply of the cathode 20 with the adjusting device 70, it is possible to vary the wavelength of the generated wave by a large value with relatively small movements of the mobile elements 72, 76, and therefore to vary the wavelength of the generated wave over a wide wavelength range, while preserving a device 10 with a small bulk.

Preferably, the generating device 10 is adapted to amplify a mode π of the radiofrequency wave, i.e. a mode of the wave such that two consecutive resonant cavities 42 oscillate in phase opposition. Due to the “rising sun” configuration of the device 10, the large cavities 52 thus all oscillate in phase with one another and the small cavities 54 also all oscillate in phase with one another, each large cavity 52 oscillating in phase opposition with each small cavity 54.

The large cavities 52 make up the output cavities, the portion of the radiofrequency wave picked up at each waveguide 24 is thus in phase with the portion of the wave picked up at each other waveguide 24. It is thus particularly easy to add said wave portions so as to reconstitute the radiofrequency wave without interference between the different wave portions and therefore without signal loss.

This makes it possible to increase the output of the generating device 10.

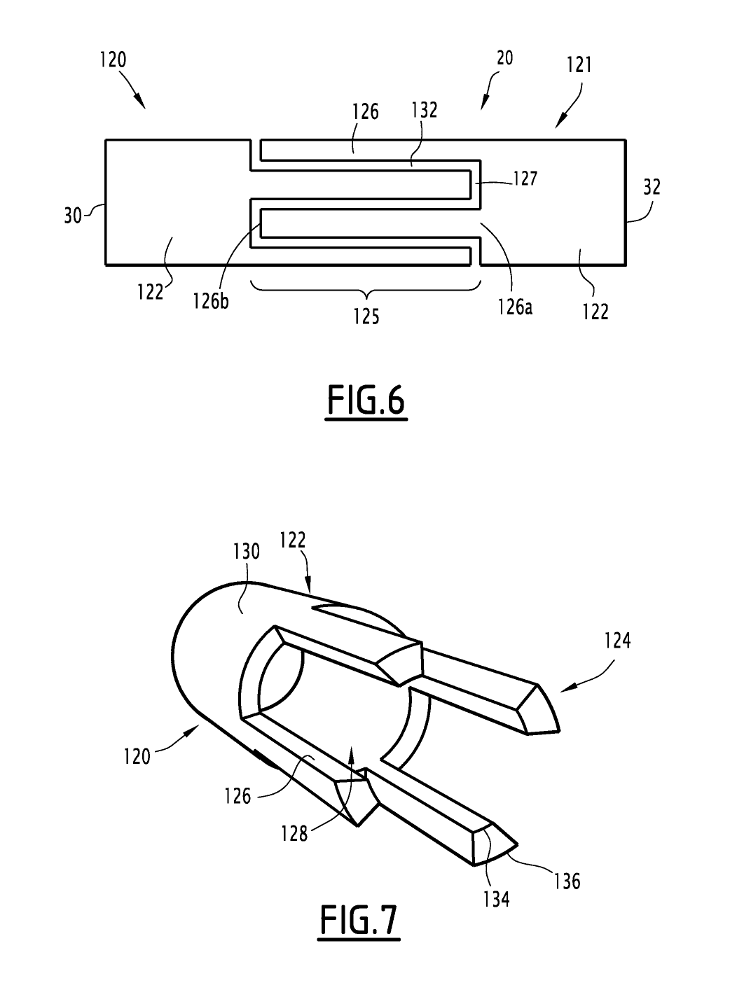

In the alternative illustrated in FIGS. 6 and 7, the cathode 20 comprises two independent portions 120, 121 electrically insulated from one another. A first portion 120 defines the first end 30 of the cathode 20, and a second portion 121 defines the second end 32 of the cathode 20.

Each portion 120, 121 comprises a solid cylindrical end segment 122, and an openwork segment 124. The portions 120, 121 are arranged head-to-tail, and the openwork segments 124 are engaged in one another, so that together they form a central openwork segment 125 of the cathode 20, and each end segment 122 defines a longitudinal end 30, 32 of the cathode 20.

The openwork segment 124 of each portion 120, 121 comprises a plurality of bars 126 extending longitudinally from a longitudinal end of the end segment 122 toward the end segment 122 of the other portion 120, 121. Each bar 126 is linked by a first end 126a with the end segment 122 of the portion 120, 121, the second end 126b of each bar 126 being free. An empty space 127 is formed between the free end 126b of each bar 126 and the end segment 122 of the other portion 120, 121 of the cathode 20.

Each bar 126 extends along the periphery of the anode 20, so that the bars 126 define, together and with the end segments 122, an empty inner chamber 128. Each bar 126 defines a portion of the outer surface 130 of the cathode 20.

A window 132 extends between each consecutive pair of bars 126. Each window 132 emerges in the outer surface 130 and in the inner chamber 128.

The portions 120, 121 are positioned so that their openwork segments 124 are interwoven, i.e. each bar 126 of each pair of consecutive bars is part of a different portion 120, 121 from the portion 120, 121 to which the other bar 126 of said pair of consecutive bars belongs.

As shown in FIG. 7, each bar 126 has a substantially trapezoidal radial section, the small side 134 of the trapezoid being oriented toward the chamber 128 and the large side 136 being oriented toward the outside.

Thus, the two ends 30, 32 of the cathode 20 are electrically insulated from one another, which makes it possible to avoid the circulation of electrical current from one end 30, 32 to the other.

Furthermore, the interwoven arrangement of the bars 126 of each portion 120, 121 makes it possible, at a constant longitudinal magnetic field intensity, to increase the potential difference between the cathode 20 and the anode 22, which makes it possible to increase the power of the wave generated by the device 10 while preserving a generating device 10 with a reduced weight and bulk.

Lastly, the two portions 120, 121 together make up a so-called transparent cathode that makes it possible to accelerate the start-up of the generating device 10, in particular by more quickly accessing a stable radiofrequency wave generator state than the traditional cathodes.

1-10. (canceled)

11. A device for generating hyperfrequency waves, of the magnetron type, comprising:
a cathode, elongated in a longitudinal direction (Z), between first and second longitudinal ends,
an anode, surrounding the cathode and comprising an inner surface oriented toward the cathode and delimiting a plurality of resonant cavities distributed along the periphery thereof, the anode also comprising an outer surface, opposite the inner surface, and
a voltage source, to establish a potential difference between the cathode and the anode,
the cathode being electrically connected to the voltage source by each of its longitudinal ends, to bring those two ends to substantially equal electric potentials, and in that the generating device comprises a device for adjusting the longitudinal length (l) of each resonant cavity, the longitudinal length (l) being defined between the longitudinal ends of the resonant cavity, the adjusting device comprising at least one mobile element defining a longitudinal end of at least one resonant cavity.

12. The hyperfrequency wave generating device according to claim 11, the adjusting device comprises at least one first mobile element delimiting a first longitudinal end of at least one resonant cavity, at least one second mobile element delimiting a second longitudinal end of the or each resonant cavity, and means for moving each mobile element longitudinally.

13. The hyperfrequency wave generating device according to claim 12, the plurality of resonant cavities comprises at least one resonant output cavity comprising an output portion emerging in the outer surface of the anode, the output portion being symmetrical relative to a median radial plane perpendicular to the longitudinal direction (Z), and in that the movement means are adapted to move each mobile element so that the or each resonant output cavity remains symmetrical relative to the median radial plane of the output portion.

14. The hyperfrequency wave generating device according to claim 12, the adjusting device comprises a single first mobile element and a single second mobile element, each mobile element being shared by all of the resonant cavities, and in that the movement means of each mobile element comprise a plurality of screw-nut systems, to convert a rotational movement of the screw into a translational movement of the screw, and a system for rotating each screw using a belt.

15. The hyperfrequency wave generating device according to claim 11, the anode is symmetrical relative to a median radial plane, perpendicular to the longitudinal direction (Z), and in that the cathode comprises an electron source, adapted to free the electrons from the cathode toward the anode, the electron source being situated substantially in the median radial plane of the anode.

16. The hyperfrequency wave generating device according to claim 11, the voltage source comprises two voltage generators, each voltage generator being electrically connected to a single longitudinal end of the cathode, and in that the generating device comprises a control module, adapted to control a simultaneous start-up of both voltage generators.

17. The hyperfrequency wave generating device according to claim 11, the plurality of resonant cavities comprises a plurality of resonant output cavities each comprising an output portion emerging in the outer surface of the anode, and a plurality of intermediate cavities inserted between the output cavities, the number of intermediate cavities inserted between two consecutive output cavities being equal to each pair of consecutive output cavities.

18. The hyperfrequency wave generating device according to claim 11, the voltage source comprises two voltage generators, each voltage generator being electrically connected to a single longitudinal end of the cathode, each voltage generator comprising at least one capacitor to supply the cathode with energy.

19. The hyperfrequency wave generating device according to claim 11, the voltage source comprises two branches for powering one end of the cathode, each branch extending from the anode to an end of the cathode, each branch being electrically identical to the other branch.

20. The hyperfrequency wave generating device according to claim 11, the longitudinal ends of the cathode are electrically isolated from one another.
